(19) United States
(12) Patent Application Publication
(10) Pub. No.: US 2015/0324939 A1
(43) Pub. Date: Nov. 12, 2015

(54) REAL-ESTATE CLIENT MANAGEMENT METHOD AND SYSTEM

(71) Applicant: Ashutosh Malaviya, Cupertino, CA (US)

(72) Inventor: Ashutosh Malaviya, Cupertino, CA (US)

(21) Appl. No.: 14/615,444

(22) Filed: Feb. 6, 2015

Related U.S. Application Data
(60) Provisional application No. 61/950,134, filed on Mar. 9, 2014.

(51) Int. Cl. G06Q 50/16; H04L 29/08; G06F 17/30; G06Q 30/02

(52) U.S. Cl. CPC G06Q 50/16; G06Q 30/0269; H04L 67/22; G06F 17/30595; G06F 17/30528

(57) ABSTRACT

In one aspect, a computer-implemented method of real-estate entity segmentation includes classifying a set of property attributes of one or more real-estate entities using a logistic regression method. The real-estate entities are taken from a realtor's client contact list. A probability of a real-estate transaction occurring for each of the one or more real-estate entities is determined based on the set of property attributes of the one or more real-estate entities. A step includes identifying that a real-estate entity is more likely being sold or listed when the probability of a real-estate transaction occurring is above a specified threshold. The real-estate entity that is more likely being sold or listed is included in a clustering data set. A step includes implementing a fuzzy-C means clustering algorithm on all or a portion of the clustering data set to obtain a cluster center for a specified set of the property attributes. The real-estate entity is classified to a real-estate segment based on a location of the real entity in the cluster. The real-estate entity is added to the real-estate segment.

### CROSS-REFERENCE TO RELATED APPLICATIONS

This application claims priority to U.S. provisional patent application No. 61/950,134, titled METHODS AND SYSTEMS OF OBTAINING, DISPLAYING AND MODELING REAL-ESTATE DATA, and filed on Mar. 9, 2014. This application is incorporated herein by reference.

### BACKGROUND

1. Field

This application relates generally to real estate services, and more specifically to a system, article of manufacture and method of real-estate client management.

2. Related Art

A realtor can have a client-contact list. The realtor may wish to implement a marketing campaign for persons in the client-contact list. However, some clients may have a low probability of moving or purchasing a new home. Other clients may have a higher probability of moving in the near future but may be wishing to downsize into smaller or less expensive homes (e.g. ‘moving down’). Still other clients may also have a higher probability of moving into a larger or more expensive home (e.g. ‘moving up’). A realtor may wish to obtain a deeper understanding of future client behavior.

### BRIEF SUMMARY OF THE INVENTION

In one aspect, a computer-implemented method of real-estate entity segmentation includes classifying a set of property attributes of one or more real-estate entities using a logistic regression method. The real-estate entities are taken from a realtor's client contact list. A probability of a real-estate transaction occurring for each of the one or more real-estate entities is determined based on the set of property attributes of the one or more real-estate entities. A step includes identifying that a real-estate entity is more likely being sold or listed when the probability of a real-estate transaction occurring is above a specified threshold. The real-estate entity that is more likely being sold or listed is included in a clustering data set. A step includes implementing a fuzzy-C means clustering algorithm on all or a portion of the clustering data set to obtain a cluster center for a specified set of the property attributes. The real-estate entity is classified to a real-estate segment based on a location of the real entity in the cluster. The real-estate entity is added to the real-estate segment.

### BRIEF DESCRIPTION OF THE DRAWINGS

The present application can be best understood by reference to the following description taken in conjunction with the accompanying figures, in which like parts may be referred to by like numerals.

FIG. 1 illustrates an example process for enhancing advertisements to a realtor contact population, according to some embodiments.

FIG. 2 illustrates an example process for matching real-estates entities with information for a realtor's client/client list, according to some embodiments.

FIGS. 3 A-C illustrate example portions of a data dictionary used to determine a client segment, according to some embodiments.

FIG. 4 depicts an example process of a contact match API, according to some embodiments.

FIGS. 5 A-B illustrates various versions of an example method of real-estate entity (e.g. a residential house, etc.) segmentation, according to some embodiments.

FIG. 6 depicts, in block diagram format, an example system for matching real-estates entities with information for a realtor's client/client list, according to some embodiments.

FIG. 7 depicts, in block diagram format, an example real-estate analysis server, according to some embodiments.

FIG. 8 is a block diagram of a sample computing environment that can be utilized to implement some embodiments.

FIG. 9 depicts an exemplary computing system that can be configured to perform any one of the processes provided herein.

The Figures described above are a representative set, and are not an exhaustive with respect to embodying the invention.

### DETAILED DESCRIPTION

Disclosed are a system, method, and article of manufacture of real-estate client management. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

The following are example definitions that can be utilized to implement some embodiments.

Cluster analysis or clustering is the task of grouping a set of objects in such a way that objects in the same group (called a cluster) are more similar (in some sense or another) to each other than to those in other groups (clusters).

Data aggregator can be an organization involved in compiling information from detailed databases on individuals and providing that information to others.

Database management system (DBMS) can be a computer program (or more typically, a suite of them) designed to manage a database, a large set of structured data, and run operations on the data requested by numerous users, processes, etc.

Event rate a measure of how often a particular statistical event (such as those discussed infra) occurs within the experimental group (such as those discussed infra) of an experiment.

Fuzzy clustering is a class of algorithms for cluster analysis in which the allocation of data points to clusters is not “hard” (all-or-nothing) but “fuzzy” in the same sense as fuzzy logic.

Customer relationship management (CRM) can be a system for managing a company's interactions with current and future customers. It often involves using technology to organize, automate and synchronize sales, marketing, customer service, and technical support.

Extensible Markup Language (XML) is a markup language that defines a set of rules for encoding documents in a format which is both human-readable and machine-readable.

JavaScript Object Notation (JSON) can be an open standard format that uses human-readable text to transmit data objects consisting of attribute-value pairs. JSON can be used to transmit data between a server and web application (e.g. as an alternative to Extensible Markup Language (XML)).

Logistic regression can include, inter alia, measuring the relationship between the categorical dependent variable and one or more independent variables, which are usually (but not necessarily) continuous, by using probability scores as the predicted values of the dependent variable.

Real estate can be property consisting of land and the buildings on it, along with its natural resources such as crops, minerals, or water; immovable property of this nature; an interest vested in this; an item of real property; buildings or housing in general.

Real estate broker or real estate agent can be a person who acts as an intermediary between sellers and buyers of real estate/real property and attempts to find sellers who wish to sell and buyers who wish to buy. As used herein, a realtor can be a real estate broker, real estate agent and/or other similar real estate profession service provider.

Representational state transfer (REST) can be an abstraction of the architecture of the World Wide Web. REST can be an architectural style consisting of a coordinated set of architectural constraints applied to components, connectors, and data elements, within a distributed hypermedia system.

Test data set can be a set of data used in various areas of information science to assess the strength and utility of a predictive relationship.

Tract can geographic region defined for the purpose (e.g. taking a census, voting precinct, other governmental region, housing tract, subdivision of a housing tract, etc.).

Training set can be a set of data used in various areas of information science to discover potentially predictive relationships. Training sets can be used in artificial intelligence, machine learning, genetic programming, intelligent systems, and statistics.

Exemplary Methods

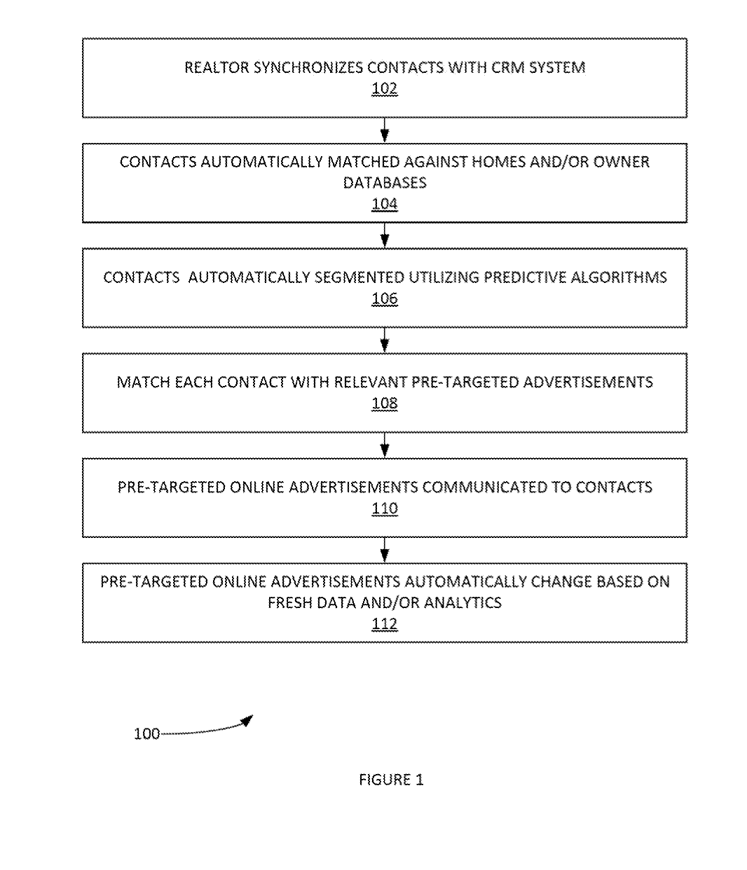

FIG. 1 illustrates an example process 100 for enhancing advertisements to a realtor contact population, according to some embodiments. In step 102 of process 100, a realtor can synchronize his/her contacts with a CRM system (e.g. a real-estate analytics service such a SmartZip Analytics real-estate analytics service). A realtor's contact list can include persons in the realtor's professional service sphere of influence, such as, inter alia, past clients, current clients, referrals, and the like. The contact list can include information about the contacts (e.g. name, address, email, etc.). The contact list can be in a computer-readable format. The contact list be communicated to the CRM system via a computer network (e.g. the Internet). The contact list can be parsed and/or otherwise processed by the CRM system. CRM system can provide an application program interface (API) that receives the contact list and/or other realtor-related information.

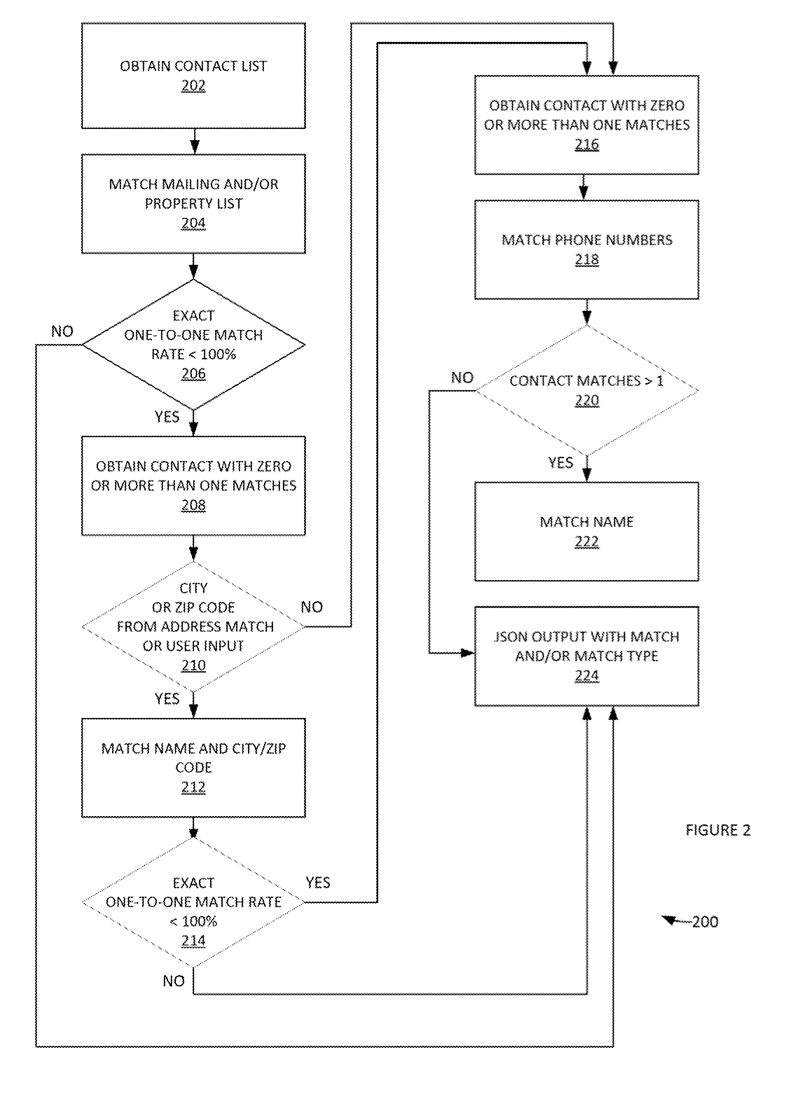

In step 104, the contact list can be automatically matched with homes and/or home owner databases. These databases can be maintained by an entity that manages the CRM system. The contacts (e.g. realtor clients) can be matched with real-estate properties with known attributes (e.g. owner demographics, real-estate property price, home size, other property details, loan details, etc.). The matching process can include an order of priority. For example, a client can first be matched to a mailing address, then to a property address, then to a name, then to a zip code or city and state, and so on. For example, if one match cannot be made provided the current content of a database, then a next order match can be attempted. For example, if no match can be made for a zip code then the client can be matched to a city and state combination. If there are no address matches are determined, then the CRM system can use possible zip codes, city or state (e.g. as provided by the user) to match against the client (e.g. a client name and/or other client identifier such as client phone number, email address and/or online social network identifier). Process 200 of FIG. 2 infra provides various examples of matching the constituent members of the contact list with real-estate entities (e.g. homes and/or home owner databases).

In step 106, the clients can be segmented utilizing various predictive algorithms. Said predictive algorithms can include statistical techniques from modeling, machine learning, and data mining that analyze current and historical facts to make predictions about future events such as those relevant to a real-estate property associated with the client. Predictive algorithms can include predictive models (e.g. scoring data with predictive models and/or forecasting), descriptive models, and/or decision models. Analytical techniques can include, inter alia: various regression techniques (e.g. linear regression model, discrete choice models, logistic regression, time series models, survival or duration analysis, classification and regression trees, multivariate adaptive regression splines, etc.); machine learning techniques (e.g. neural networks, radical basis functions, multilayer perceptrons, support vector machines, naïve Bayes, k-nearest neighbors, geospatial predictive modeling, etc.); and the like (including optimizations techniques). In one example, predictive algorithms can be utilized to segment clients into various insight categories such as, inter alia: likely to sell; likely to buy; likely to buy a more expensive home than current home (e.g. ‘move up’); likely to buy a less expensive home than current home (e.g. ‘move down’); like to refinance current home mortgage, etc. A segment can be a predicted real-estate related behavior for a client. Clients can be included into one or more segments based on known client attributes (e.g. as determined in the previous steps of process 100). One or more client segments (e.g. a predicted future action) can be included into mathematical models that are used to predict the client's future real-estate related behavior. An actionable segment can be a selected client segment that is used to predict some future client action. For example, a one or more client segments can be weighted based on various factors and a most likely actionable segment can be determined (e.g. ‘move up’, ‘ignore’, ‘move down’, etc.). So while a client may have some attributes that indicate she may ‘move down’, the weight of the available client attribute data and subsequent mathematical model(s) can still indicate a ‘move up’ is more likely. Accordingly, the client can be placed in a ‘move up’ actionable segment for purposes of the remaining steps of process 100. Various realtor actions can be recommend for the client based on her status in the ‘move up’ segment.

In step 108, each client can be matched with a targeted advertisement based on the insights/analytics of step 106. It is noted that the insights/analytics of step 106 can be used to match each client with other actions as well. In step 110, pre-targeted online advertisements can be communicated to the client. For example, the pre-targeted online advertisements can be emailed to the client. In another example, the pre-targeted online advertisements can be communicated to the client's online social networking account (e.g. tweeted to the client, posted to the client's Facebook@profile, etc.). In yet another example, an advertisement can be printed as a physical flier and mailed to a client.

In one example, it can be determined that a client in a ‘move up’ segment. The ‘move up’ segment can include a set of clients that the analytics algorithms of step 106 determine have a high probability of purchasing a more expensive real-estate property. For example, a client can be determined to have a specified probability of selling her existing home in order to buy a larger home and/or a home in a more expensive neighborhood. For example, a study of past clients with certain attributes similar to those of the client can be performed. The past study can be utilized to determine a probability the current client to behave a certain way (e.g. the client's segment). Accordingly, the pre-targeted online advertisement can be based on the most likely segment for the client. In the present example, the pre-targeted online advertisement can be a realtor (e.g. the client's real estate agent) advertisement that includes listings for more expensive and/or larger homes because the client is in the ‘move up’ segment.

It is noted that all or a portion of steps 102-106 can be re-executed on a periodic basis and/or when it is detected that new information is available. Consequently, in step 110, the pre-targeted online advertisements can be modified based on updated client segment. For example, real-estate listings in said advertisements can be modified based on availability. In another example, client's segment(s) can be modified based on fresh client data. The pre-targeted online advertisements can be modified to present real-estate offerings appropriate for the client's segment(s). It is noted that process 100 can be performed without certain specified steps. For example, step 108-110 can be ignored for some examples of process 100.

FIG. 2 illustrates an example process 200 for matching real-estates entities with information for a realtor's client/client list, according to some embodiments. In step 202, a contact list can be obtained. For example, the realtor can upload a computer-readable version of her contact list to a server-side system that implements process 200. For example, in step 204, the client/contact list (e.g. a realtor's mailing list) can be matched with a property list. The property list can be a list of real-estate entities created and/or managed by the entity that implements process 200. For example, the list of real-estate entities can be an aggregation of information from various real-estate related information sources such as third-party real-estate information aggregators, government mental entities, consumer data aggregators, etc.

In step 206, it can be determined if an exact one-to-one match rate for step 204 is less than one-hundred percent (100%). If no, then process 200 can proceed to step 224. If yes, then process 200 can proceed to step 208. In step 208, a contact with ‘zero’ (0) or more than one (>1) matches can be obtained. For example, process 200 can query a database, or otherwise acquires information regarding the contacts and their respective number of matches.

In step 210, it can be determined if zip code and/or city information from an address match and/or client provided information is available. If no, then process 200 can proceed to step 216. If yes, then process 200 can proceed to step 212. In step 212, the contact can be matched with at least one zip code and/or city information.

In step 214, it can be determined if the output of step 212 has an exact one-to-one match rate for step 204 is less than one-hundred percent (100%). If no, then process 200 can proceed to step 224. If yes, then process 200 can proceed to step 216. In step 216, a contact with ‘zero’ (0) or more than one (>1) matches can be obtained. In step 218, the telephone numbers of the contact(s) can be matched with the output of step 216. Process 200 can then proceed to step 220.

In step 220, it can be determined if the contact matches are greater than one (1). If no, then process 200 can proceed to step 224. If yes, then step 220 can proceed to step 222. In step 222, the contact can be matched with a name. In step 224, a JSON (or other an alternative such as XML or the like) with match and/or match type can be provided. It is noted that all or portions of process 200 can be repeated for each contact provided by the realtor. In some examples, process 200 can be implemented by contact matcher application programming interface (API) infra.

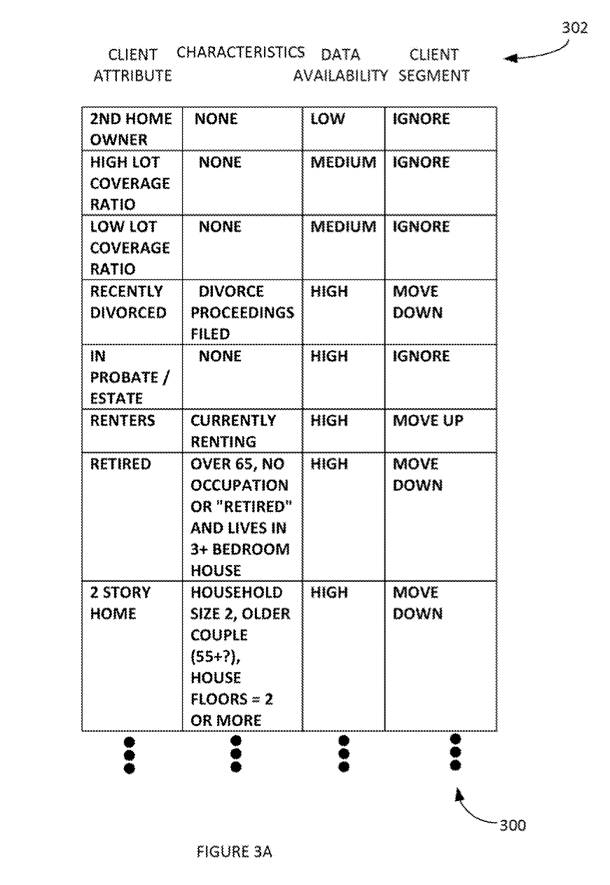

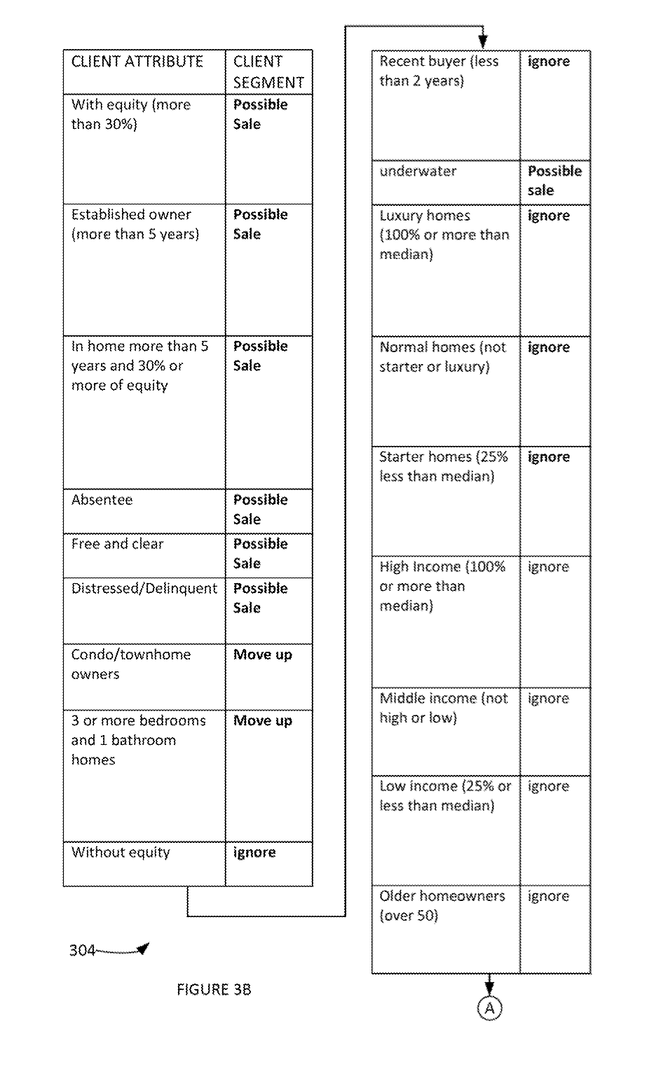

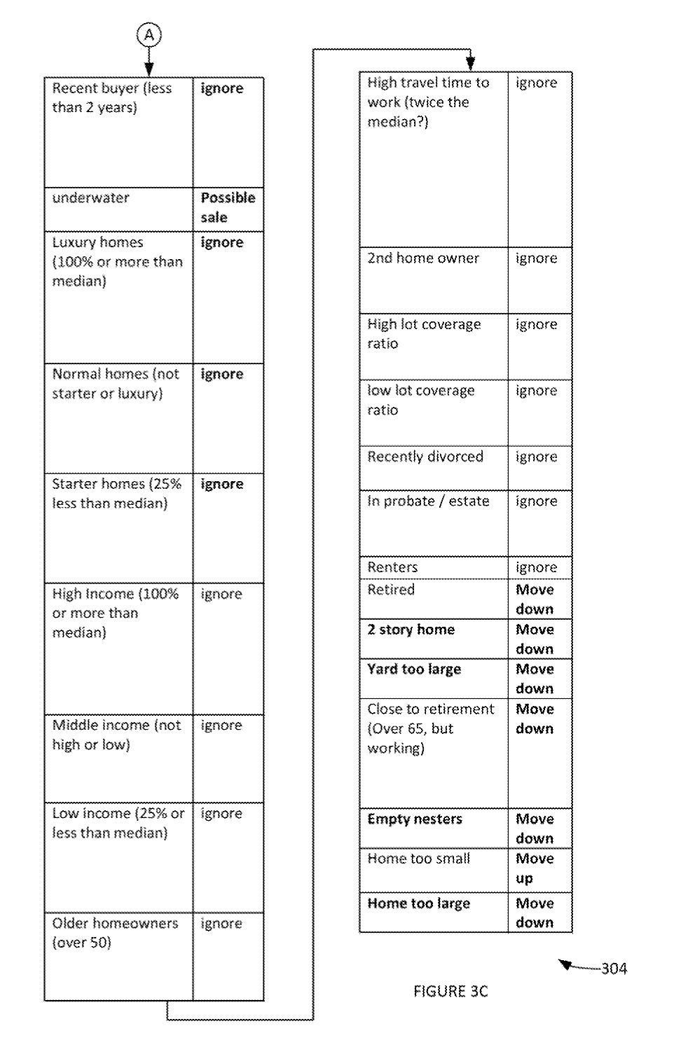

FIGS. 3 A-B illustrate example portions of a data dictionary 300 used to determine a client segment, according to some embodiments. The data dictionary can be a centralized repository of client and/or real-estate related information about data such as meaning, relationships to other data, origin, usage, and format. Data dictionary 300 can include information obtained about one or more clients of a realtor. Each client can be associated with a data dictionary that includes information obtained about said client. The information can be obtained from third-party data aggregation services and matched with the client (e.g. as provided in process 200). This information can be parsed and included into the appropriate fields 302 of the data dictionary. In one example fields 302 can include various client attributes. Client attributes can include various possible attributes that can be associated with a client. Values and/or states associated with the client attributes field can be provided in the characteristics fields. A value for the data used to set the characteristic field can be provided in the data availability field. The information from these fields can be used to set a value for the client segment field. Client segment field values can be used to determine a client segment. As noted supra, a client segment can be utilized to determine an action to be taken with respect to the client. For example, an online advertisement can be automatically generated based on a client segment. The online advertisement can then be provided to the client through an electronic medium such as, inter alia: email, text message, online social network, interactive media advertisements.

Element 304 illustrates two example columns of data dictionary 300. Element 304 shows a client attribute matched with a particular client segment. Information in the client attribute column can be collected from various sources as provided herein. The information can then be matched with client entities from the client list to generate the client attribute. Client attributes can be demographic characteristics, real-estate characteristics, life event characteristics, etc. These characteristics can be used in mathematical models that provide a probability that a client will behave in a specified manner with respect to a real-estate entity (e.g. her home). Accordingly, client attributes can be associated with a client segment. A client segment can provide actionable information to a realtor.

It is noted that, in some embodiments, a single actionable client segment can be selected. In some cases, multiple client attributes can lead to multiple possible client segments for selection. In such a case, various methods can be utilized to select a single client segment.

For example, client attributes can be weighted (e.g. based on an optimization algorithm run on historical client action data). A client attribute with a highest weight can be used to determine the final actionable client segment for selection. In another example, the possible client segments can be ordered in a hierarchy. The client segment with the highest rank can be used to determine the final actionable client segment for selection. Returning to the example of FIG. 3, the ‘move up’ client segment can be prioritized over the ‘move down’ category. A particular client can have two (2) attributes that qualify as ‘move down’ client segments and one (1) attribute that qualifies as a ‘move up’ client segment. However, because the ‘move up’ client segment has been set with greater precedence than the ‘move down client segment (e.g. by a system administrator), the ‘move up’ client segment can be selected as the final actionable client segment.

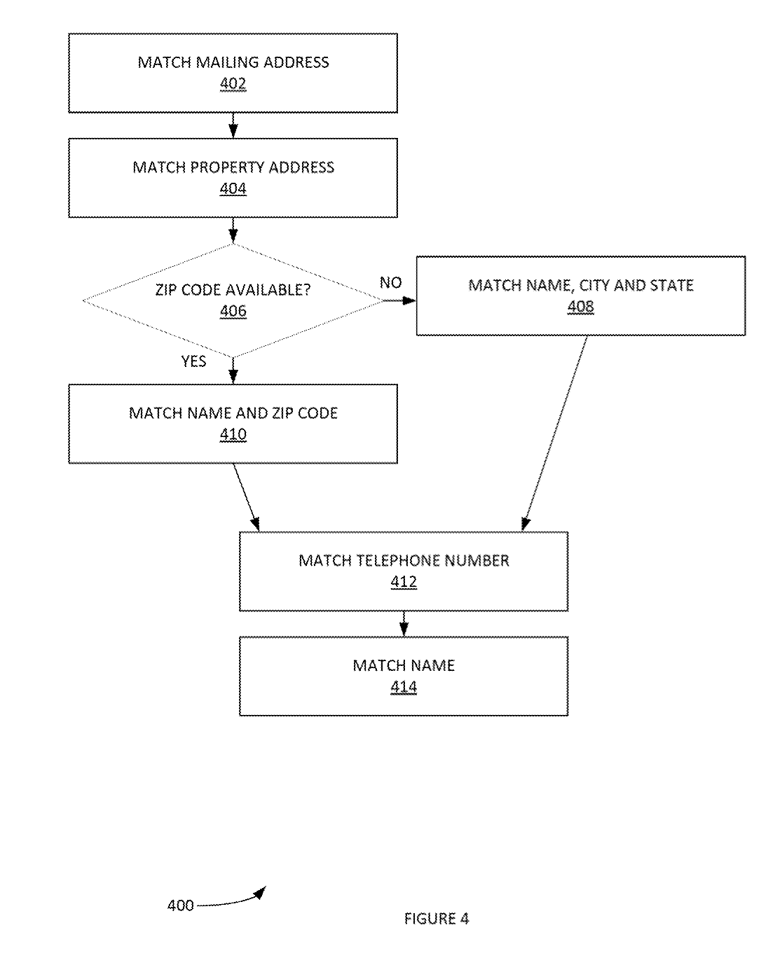

FIG. 4 depicts an example process 400 of a contact match API, according to some embodiments. A contact match API can be a REST-based web service to obtain property information for a given list of contact details. The list of list of contact details can be provided in a computer-readable format by a realtor. Process 400 provided a method of matching the entities in the list of contact details with a property and/or property-related region (e.g. a precinct, zip code, municipality, etc.) in a database of real-estate properties with known attributes (e.g. client attributes of FIG. 3, size of real-estate property, real-estate property purchase history, real-estate property owner attributes, etc.). As used here, a REST-compliant Web service can be a web service in which the primary purpose of the service is to manipulate XML (or other markup language) representations of Web resources using a uniform set of stateless operations. The contact match API can be given a list of contacts details which include, inter alia, a contact's identity, name, address, city, state, zip, phone and/or email address. The contact match API matches the given contacts to real-estate properties. A set of databases such as real-estate property databases, consumer list databases, telephone number databases, governmental property databases, etc. Process 400 includes various steps that are involved in the match. In step 402 of process 400, a match can be made between a client's mailing address and a mailing address of real-estate property in the database of real-estate properties with known attributes. In step 404, a match can be made between a client's property address and a property address of real-estate property in the database of real-estate properties with known attributes. In step 406, it can be determined if a zip code match is available. If no, then process 400 can proceed to step 408. In step 408, the contact information can be matched with a name, city and/or state information in the database of real-estate properties with known attributes. If yes, then process 400 can proceed to step 410. In step 410, the contact information can be matched with a zip code, city and/or state information in the database of real-estate properties with known attributes. In step 412, the contact information can be matched with a telephone number in a database such as a telephone number databases and other consumer mailing list databases. Example sources of telephone numbers can be LPS® and/or Natimark® (and/or other consumer data providers).

In step 414, process 400 can match the name in the contacts list can be matched with the ownership records of the real-estate property in the database of real-estate properties with known attributes. For example, a name match can be performed to narrow down the property matches. For example if in steps 402-412 certain contacts have been matched to multiple properties, then name can be used match the exact property. Two types of client-list side name matches can be utilized, inter alia: ‘Full Name’ match and/or ‘Last Name’ match. This names can be matched against the following records of a real-estate property in the database of real-estate properties with known attributes, inter alia: ‘Buyer Name’; ‘Borrower Name’; and/or ‘Owner Name’. Each step takes in as input the contacts that have zero or more than one matches. Each step helps in finding or narrowing a match depending on the previous step's match result.

It is noted that if no address matches are determined, then process 400 can use possible zip codes, city or state (e.g. as provided by the client) to match against the names. In some embodiments, other consumer identifiers can be matched with real-estate property attributes to further narrow down property matches. Accordingly, in some examples, some steps of process 400 can be removed and/or substituted with other steps that match available contact list entity information with available information in the database of real-estate properties with known attributes. In some examples, process 400 can be utilized to implement process 200.

Process 400 can be used to build data dictionary 300 of FIG. 3. An example set of fields for a contact list can be, inter alia: id; first name; last name; address; city; state; zip; phone_number.

In one example, the contact match API can return JSON output with contact_id, property_id and a three (3) digit match type. The following table illustrates an example match-type definition that can be utilized in some embodiments.

| 100th place - Address | 10th place - Phone | ones place - Name |
|---|---|---|
| 0-no address match | 0-no phone match | 0-no name match |
| 1-mail address match | 1-phone number match | 1-full name match |
| 2-property address match | | 2-last name match |
| 3-zip code match | | |

Example match-type codes that can be utilized include: 0=No Match; 100=only address match; 110=Address and phone number match; 112=Address, phone and full name match; 102=Address and last name Match; 201=Zip and full name match.

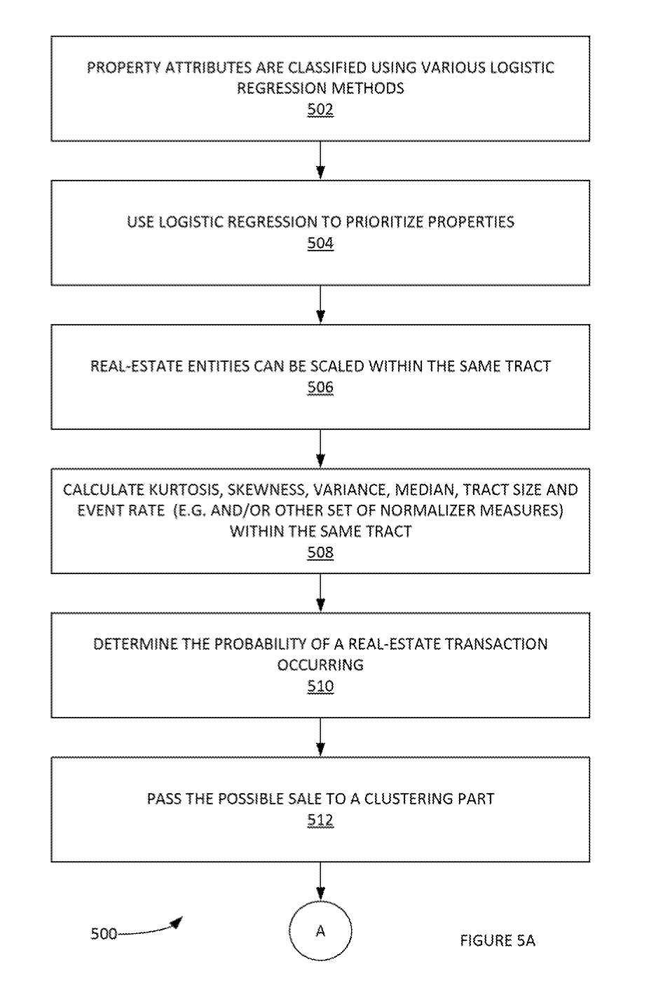

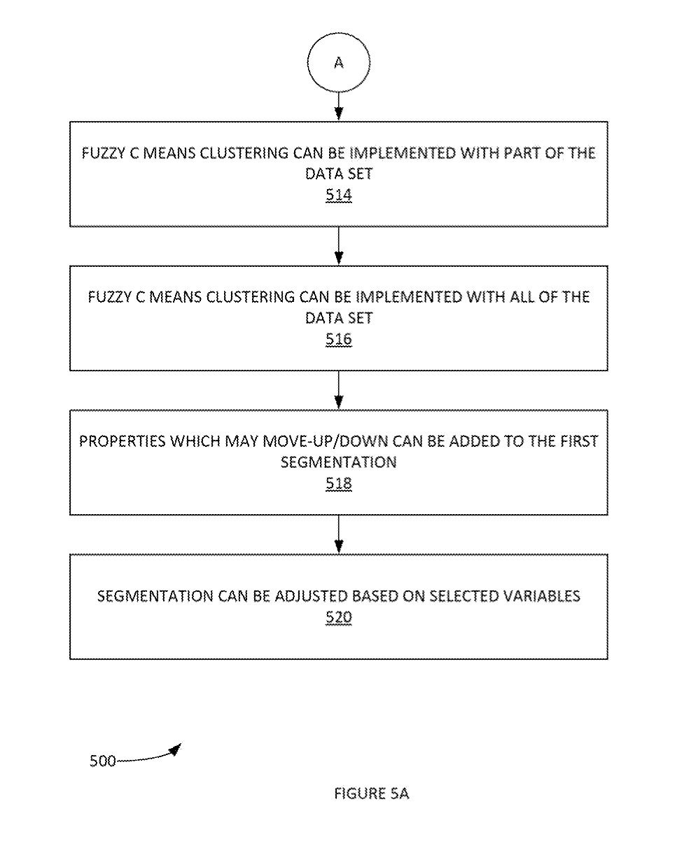

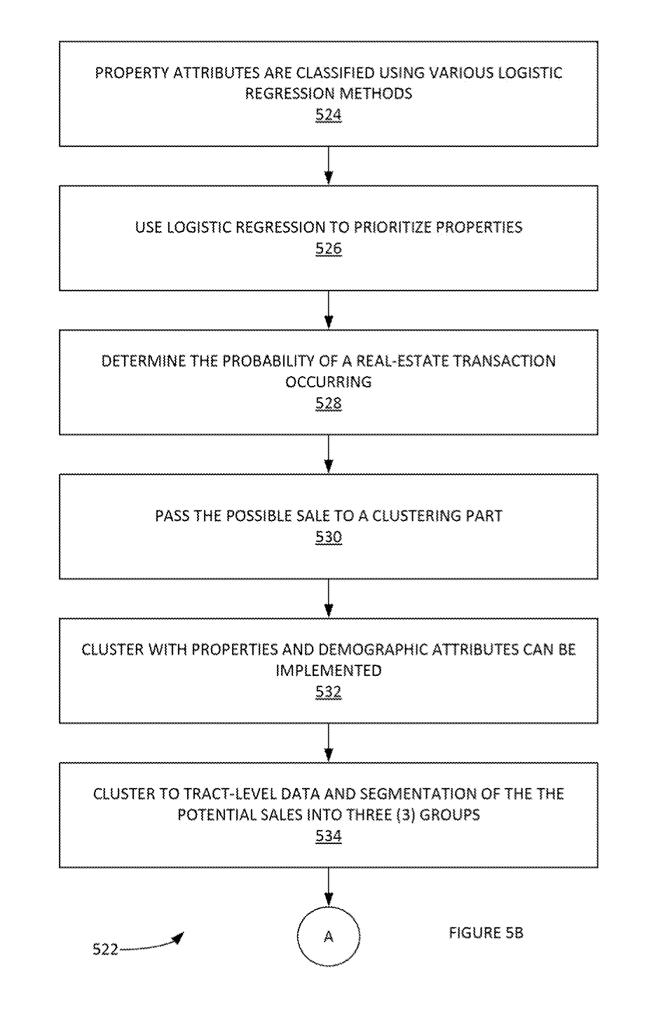

FIGS. 5 A-B illustrates various versions of an example method of real-estate entity (e.g. a residential house, etc.) segmentation, according to some embodiments. Two steps can be implemented for real-estate entity segmentation. A first step can be to identify a real-estate entity that is more likely to sell a house (and/or another real estate asset). A second step is to segment the real-estate entities into various segments, such as, for example: move-up, move-down and move-parallel.

FIG. 5A illustrates an example of method 502 of real-estate entity (e.g. a residential house, etc.) segmentation, according to some embodiments. In step 502, property attributes are classified using various logistic regression methods. In one example, the following variables can be utilized to represent property attributes: beds, year_built, sqft, current_hold_days, appr_since, sales_hy10, ltv_new, price, age_cat, unitSqft (sqft/beds), unitPrice (price/sqft). In step 504, use logistic regression to prioritize properties. In one example, the top three (3) models can be selected and combined together to re-rank properties.

In step 506, the real-estate entities can be scaled (e.g. a transformation that enlarges or diminishes an object) within the same tract. In one example, the following formula could be utilized: (prob−min(prob))i(max(prob)−min(prob)) to scale said real-estate entities within the same tract.

In step 508, the kurtosis, skewness, variance, median, tract size and event rate (and/or other set of normalizer measures) within the same tract can be calculated. For example, a contact's probabilities (e.g. contacts in a realtor's contact list) and corresponding influencers can be extracted. The kurtosis, skewness, variance, median, tract size and event rate (e.g. and/or other set of normalizer measures) influencers within contact level can be normalized. For example, the following equation can be used for normalization: influencer=(influencer−min(influencer))/(max(influencer−min(influencer)).

In step 510, determine the probability of a real-estate transaction occurring. If the probability of a real-estate transaction occurring is determined to above threshold, property, it is identified to be more likely being sold or listed. The probability threshold is determined based on F-score according to the following example method. 1) The probabilities can be adjusted. If all contacts are coming from the same tract: use probability for that property. If contacts are coming from different tracts: (use probability+w*eventRate_nonnalized)(1+w). 2) Calculate the F-score. The threshold can start from the twenty (20) percentile to eighty (80) percentile of probabilities. For example, the following equation can be utilized.

$${F}_{1} = 2 \cdot \frac{precision \cdot recall}{precision + recall} .$$

In pattern recognition and information retrieval, precision (also called positive predictive value) is the fraction of retrieved instances that are relevant, while recall (also known as sensitivity) can be the fraction of relevant instances that are retrieved. The precision measurement of this method can be the probability that among those properties that have been identified as more likely to be sold or listed, how many properties transaction are actually occurred. Recall can be the probability that among the true transactions, how many properties were correctly predicted. The largest F-score is selected along with the corresponding threshold. Accordingly, in 3) the largest F score is selected along with the corresponding ‘w’ (e.g. a weighting value).

In step 512, the possible sale can be passed to a clustering part. Accordingly, in step 514, clustering (e.g. clustering analysis) with properties and demographic attributes is implemented. Various clustering methods can be utilized, including, inter alia: hierarchical clustering, centroid-based clustering, density-based clustering, distribution-based clustering, fuzzy clustering, etc. For example, fuzzy-C means can be used to perform clustering. The following is an example of fuzzy-C means clustering. Various variables can be selected, such as, inter alia: Global: ptype_sqft/beds, ptype_price/sqft, ptype_yearBuilt, ptype_lotsize/sqft, beds/baths; partially have: price/Household_Income, Household_Income_percentile, beds/household_size, age; and/or Adjust: Num_Kids_new, age, Occ_working_wmn, Sr Adult_in_Household, Kids_{—}16_{—}17. Ptype can be a propertype. Sqft can be a square foot value of a property. Kids_{—}16_{—}17 can be a number of children of ages sixteen (16) and/or seventeen (17) living in a home (e.g. soon to be college going kids can be a move down indicator). Occ_working_wmn can represent an occupation of woman living in the home.

In step 514, fuzzy C means clustering can be implemented with part of the data set. Continuing with the previous example, the following variables can be scaled within the same tract: ptype_price/sqft, ptype_sqft/beds, ptype_yearBuilt, ptype_lot/sqft, beds/baths, beds/house_hold_size, price/income, income_percentile (e.g. income percentile of owner/household); and age (e.g. age of home owner, average age of house hold, etc.). 1) Build fuzzy c means and set cluster number equals to three (3). 2) Obtain cluster centers, and segment properties by majority vote (e.g. weighted majority algorithm (WMA)). The following table can be referenced and utilized.

| Variables | Up | Down | Variables | Up | Down |
|---|---|---|---|---|---|
| ptype_yearBuilt | min | NA | HH_income_perc | max | min |
| ptype_sqft/beds | min | max | price/HH_income | min | max |
| ptype_lot/sqft | min | max | beds/hh_size | min | max |
| beds/baths | max | NA | age | min | max |

In step 516, fuzzy C means clustering can be implemented with all of the data set. Various variables can be selected. Continuing with the previous example, the following variables within the same tract: ptype_price/sqft, ptype_sqft/beds, ptype_yearBuilt, ptype_lot/sqft, beds/baths. The following steps can be implemented with these variables. 1) Build fuzzy c means and set cluster number equals to three (3). 2) Obtain cluster centers, and segment properties by majority vote. The following table can be referenced and utilized.

| Variables | Up | Down |
|---|---|---|
| ptype_yearBuilt | min | NA |
| ptype_sqft/beds | min | max |
| ptype_lot/sqft | min | max |
| beds/baths | max | min |

In step 518, the properties which may move-up/down can be added to the first segmentation. In step 520, the segmentation can be adjusted based on selected variables such as, inter alia: working_woman, sr_adults, kids_{—}16_{—}17, etc.

Figure SB illustrates another example of method 522 of real-estate entity (e.g. a house, etc.) segmentation, according to some embodiments. In step 524, property attributes are classified using various logistic regression methods. In one example, logistic regression can be used for the classification. For example, consider the following variables: beds, year_built, sqft, current_hold_days, appr_since, sales_hy10, It new, price, age_cat, unitSqft (sqft/beds), unitPrice (price/sqft). Current_hold_days can be after last transaction how long owner has been living in house. Appr_since can be an appreciation value since a last transaction. Age_cat can represent an age category of owner in a range of years (e.g. in 20-30, 50-60, increments, etc. ltv_new can be a loan to value variable. In step 526, logistic regression is used to prioritize properties. For example, the top three (3) models can be used and combined together to re-rank properties.

In step 528, determine the probability of a real-estate transaction occurring. If the probability of a real-estate transaction occurring is determined to above threshold, property, it is identified to be more likely being sold or listed. The threshold is determined based on F-score. The F-score can be calculated. The threshold is starting from the twenty (20) percentile to (80) percentile of probabilities.

The F-score can be twice the ration of (precision times recall/precision plus recall). The largest F-score and corresponding threshold can be selected. In step 530, the possible sale can be passed to a clustering part. Accordingly, in step 532, clustering with properties and demographic attributes can be implemented. For example, in step 534, clustering to tract-level data and segmentation of the potential sales into three (3) groups (e.g. move-up/down/parallel) can be implemented. However, step 534 can be implemented without scaling the data set as in process 500. In step 536, the properties within the first-pass classification can be extracted. In step 538, the segmentation can be adjusted (e.g. based on working_woman, sr_adults, kids_{—}16_{—}17, etc.). Sr_adults can be number of senior citizens adults living in household.

It is noted that processes 500 and/or 522 can be modified (e.g. other non-residential house related variable used) for real-estate analysis of other types of properties such as, inter alia: commercial properties, mineral rights, easements, water rights, meter rights, etc.

An alternative set of clustering steps to those provided in FIG. 5 are now provided. Variables referred to this example alternative clustering process can be found infra (e.g. see the data dictionary infra). The same clustering to tract-level data of process 500 can be implemented. The potential sales can be segmented the potential sale into three (3) groups: move-up/down/parallel. After this step, additional scaling steps need not be performed. The some variables (e.g. lot_size, year_built, sqft, beds, ptype and price) are reviewed to determine if values are missing. If yes, these missing variable values are filled the block median first and then, if still missing, the tract median is used. Outlier data data points are then removed. The clustering variables (e.g. ptype_price/sqft, ptype_sqft/beds, ptype_yearBuilt, ptype_lot_size/sqft) can be identified. A modeling phase can be implemented. For example, the cluster number to three (3). The values of the ‘Up’ variables (e.g. min(ptype_unitLot), min(ptype_yearBuilt), min(ptype_unitSqft)) can be determined. The values of the ‘Down’ variables (e.g. max(ptype_unitLot), max(ptype_yearBuilt), max(ptype_unitSqft) can be determined. A majority vote classification process can be implemented. Which centers are moved-up/down/ and parallel can then be chosen. Some properties can have demographic variables, such as for example, hh_size, HH_Income. If part of data is missing, it can be filled with a block median and, if still missing, a tract median.

Clustering variables can include, inter alia: ptype_price/sqft, ptype_sqft/beds, ptype_yearBuilt, ptype_lot_size/sqft, age, unitHHsize (beds/hh_size), bedBath (beds/baths), HH_Income_Percentile(HH_Income/median(HH_Income)), priceIncome (price/HH_Income). A modelling process can then be implemented. For example, a cluster number to three (3). The values of the ‘Up’ variables (e.g. max(HH_Income_Percentile), min(priceIncome), min(unitHHsize), max(bedBath), min(ptype_unitLot), min(ptype_yearBuilt), min(ptype_unitSqft), min(age). The values of the ‘Down’ variables (e.g. min(HH_Income_Percentile), max(priceIncome), max(ptype_unitSqft), max(age)) can be determined. A majority vote classification process can be implemented. Choose which centers are moved-up/down/ and parallel. In one example, demographic data (second part) may be missing, the result from first part can then be used. If demographic data is available, the result from second part can be used. The rest result from first part can used. The properties within the first pass classification can be extracted. The segmentation can be adjusted based on various variables such as: working_woman, sr_adults, kids 16_{—}17.

Exemplary Environment and Architecture

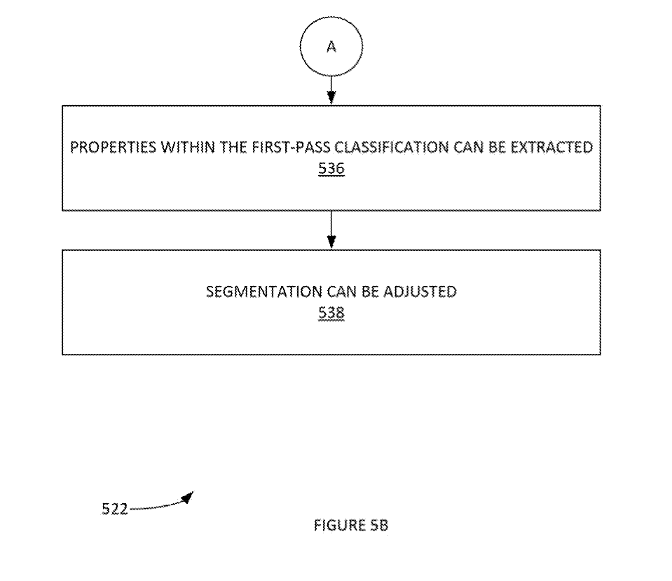

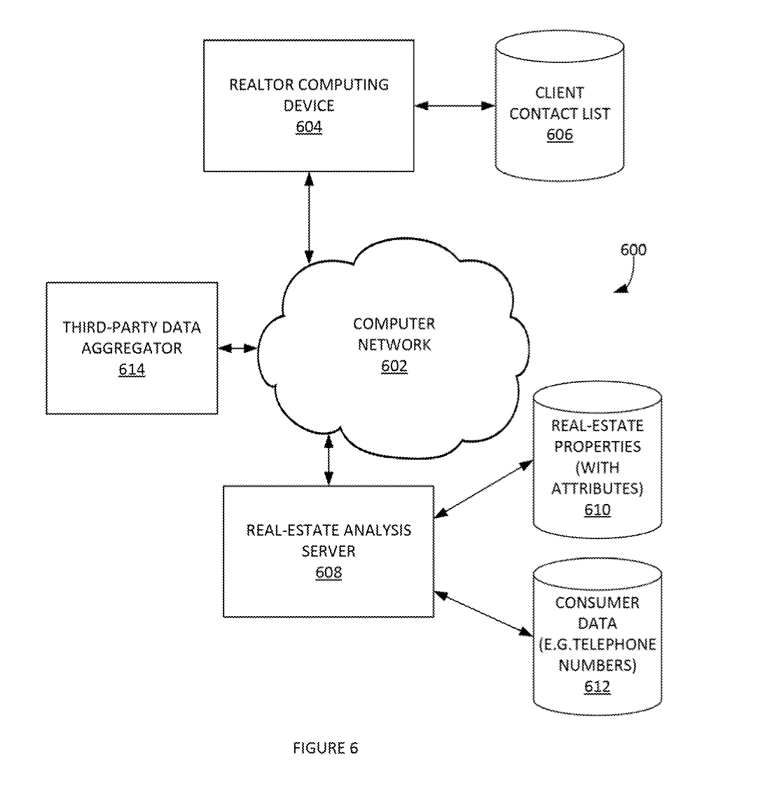

FIG. 6 depicts, in block diagram format, an example system 600 for matching real-estates entities with information for a realtor's client/client list, according to some embodiments. System 600 can include one or more computer networks 602 (e.g. TCP-based network (such as the Internet), a cellular data network, an enterprise private network, etc.). System 600 can be accessed by a realtor's computing device 604. A realtor can utilize realtor computing device 604 to communicate one or more realtor client contact list 606 to real-estate analysis server 608. For example, realtor computing device 604 can include an application (e.g. a client-side CRM application) that network protocol used to transfer computer files from one host to another host over computer networks 602. Client contact list 606 can be list of one or more realtor's clients stored in a database format.

Real-estate analysis server 608 can receive be communicatively coupled with an application of realtor computing device 604. Real-estate analysis server 608 can implement various server-side CRM functionalities. Real-estate analysis server 608 can receive a client list (e.g. the client contact list 606) from realtor computing device 604. Real-estate analysis server 608 can perform analytics on client contact list 606. Client contact list 606 can include a contact's name, telephone number, address, demographic information, etc. Real-estate analysis server 608 can implement the various processes of FIGS. 1-5. Real-estate analysis server 608 can match the entities in client contact list 606 with real estate entities (e.g. residential homes, municipalities, home owners, zip codes, etc.) of real-estate properties database 610. Real-estate analysis server 608 can provide analytics and insights to realtor's computing device 604 (e.g. utilizing TCP-based data packets).

Real-estate properties database 610 can include a set of real-estate properties and/or various attributes of real-estate properties. Real estate entities can have various attributes. Real-estate analysis server 608 can utilize the attributes of a real-estate entity matched with a client contact list entity to determine an actionable segment in which to include the client contact list entity. An actionable segment can be a client segment selected for a specific action. Real-estate analysis server 608 can generate various analytics and insights (e.g. a client has a calculated probability of moving up, moving down or doing nothing within a certain time flame) that can assist realtors in interacting with his/her clients. Real-estate analysis server 608 can provide said analytics and insights about a realtor's contact list to said realtor. Real-estate analysis server 608 can performs actions based on an identified actionable segment for each contact entity (e.g. a person in a realtor's contact list). Real-estate analysis server 608 can generate advertisements targeted based on the actionable segment assigned to a client.

Third-party data aggregator(s) 614 can include various consumer data providers, governmental agencies, etc. Third-party data aggregator(s) 614 can obtain real-estate related data and provide said data (e.g. via a computer-readable medium, with an API, etc.) to real-estate analysis server 608. Third-party data aggregator(s) 614 can be implemented in one or more servers and/or cloud-computing platforms. Example third-party aggregators include county assessors (and/or other government providers of real-estate, taxation, property information, etc.), LPS® and/or Natimark® (and/or other consumer data providers).

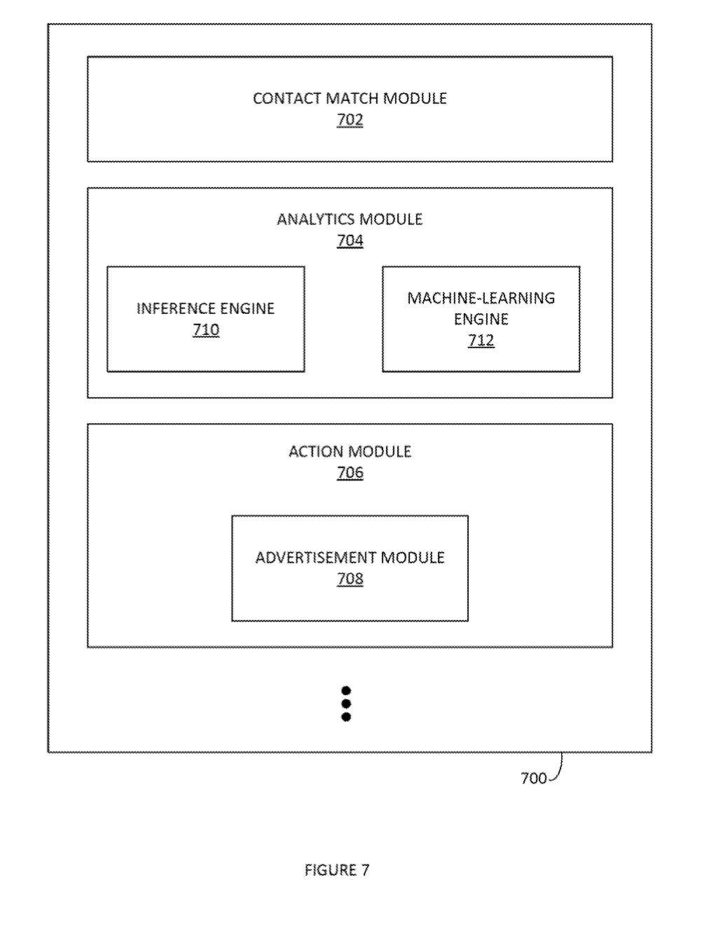

FIG. 7 depicts, in block diagram format, an example real-estate analysis server 700, according to some embodiments. Real-estate analysis server 700 can be implemented in a server computing device and/or in a cloud-computing platform. Real-estate analysis server 700 can be used to implement real-estate analysis server 608 of FIG. 6. Real-estate analysis server 700 can be used to implement the processes and methods of FIGS. 1-5.

Real-estate analysis server 700 can synchronize with a client-side CRM application and obtain a contact list of a realtor. Real-estate analysis server 700 can include a DBMS that manages a plurality of databases. For example, real-estate analysis server 700 can manage a database of real-estate properties (e.g. with property and/or owner attributes), a database of consumer data (e.g. telephone numbers, etc.) and the like. Real-estate analysis server 700 can match the real-estate and/or consumer data with the entities in the contact list from the realtor. Real-estate analysis server 700 can provide an actionable segment for each entity of the contact list based on the various attributes associated with the real-estate property matched to the contact list. Real-estate analysis server 700 can implement various actions (e.g. generate advertisements, generate analytics reports with actionable information to realtor that provided the contact list, etc.) based on the actionable segments for each entity of the contact list.

More specifically, in some example embodiments, real-estate analysis server 700 can include a contact match module 702. Contact match module 702 can match the real-estate and/or consumer data with the entities in the contact list from the realtor. Contact match module 702 can use processes 100, 200 and 400 (as well as data dictionary 300). Contact match module 702 can implement a contact match API (e.g. as provided supra in the description of FIG. 4). Contact match module 702 can include a geocoding functionality that enriching a description of a real-estate entity's location (e.g. a postal address, place name, etc.) with geographic coordinates from spatial reference data such as building polygons, land parcels, street addresses, ZIP codes (e.g. postal codes) and so on.

Analytics module 704 can implement various analytics algorithms to identify the attributes of the real-estate and/or owners matched to a contact list entity. These attributes can be identified from, realtor provided information (e.g. contact list details), various real-estate information databases (e.g. real-estate properties database 610, etc.) and/or consumer information databases (e.g. consumer data 612, etc.). Analytics module 704 can draw inferences from the attributes of the real-estate and/or owners matched to a contact list entity (e.g. a specified probability to move, a specified probability to purchase a larger and/or more expensive home, a specified probably to sell a current home and purchase a smaller and/or less expensive home, a specified probability to refinance within a time period, etc.). Analytics module 704 can assign an actionable segment (e.g. example possible actionable segments are shown in the client segment column of FIG. 3) to a contact list entity based on these attributes and/or inferences.

Analytics module 704 can include an inference engine. Inference engine 710 can draw conclusions by analyzing database content, in light of a database of expert knowledge it draws upon. Inference engine 710 can reach logical outcomes based on the premises the data establishes. Inference engine 710 can also utilize probability calculations to reach conclusions that the knowledge database doesn't strictly support, but instead implies. In one example, the inference engine can cycle through three sequential steps: match rules, select rules, and execute rules. The execution of the rules can result in new facts or goals being added to the knowledge base which will trigger the cycle to repeat. This cycle can continue until no new rules can be matched. Accordingly, the list of actionable real-estate information provided to a realtor can be generated and refined.

It is noted that databases described herein can be automatically sampled by the statistical algorithm. There are several methods which may be used to select a proper sample size and/or use a given sample to make statements (within a range of accuracy determined by the sample size) about a specified population. These methods may include, for example:

1. Classical Statistics as, for example, in “Probability and Statistics for Engineers and Scientists” by R. E. Walpole and R. H. Myers, Prentice-Hall 1993; Chapter 8 and Chapter 9, where estimates of the mean and variance of the population are derived.

2. Bayesian Analysis as, for example, in “Bayesian Data Analysis” by A Gelman, 1. B. Carlin, H. S. Stern and D. B. Rubin, Chapman and Hall 1995; Chapter 7, where several sampling designs are discussed.

3. Artificial Intelligence techniques, or other such techniques as Expert Systems or Neural Networks as, for example, in “Expert Systems: Principles and Programming” by Giarratano and G. Riley, PWS Publishing 1994; Chapter 4, or “Practical Neural Networks Recipes in C++” by T. Masters, Academic Press 1993; Chapters 15, 16, 19 and 20, where population models are developed from acquired data samples.

4. Latent Dirichlet Allocation, Journal of Machine Learning Research 3 (2003) 993-1022, by David M. Blei, Computer Science Division, University of California, Berkeley, Calif. 94720, USA, Andrew Y. Ng, Computer Science Department, Stanford University, Stanford, Calif. 94305, USA

It is noted that these statistical and probabilistic methodologies are for exemplary purposes and other statistical methodologies can be utilized and/or combined in various embodiments. These statistical methodologies can be utilized in whole or in part as well.

Analytics module 704 can include a machine learning engine 712. Machine learning engine 712 can learn from historical real-estate information. This can be used to increase the accuracies the actionable segments for a contact-list entity selected by analytics module 704. Machine learning can include the construction and study of systems that can learn from data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Action module 706 can implement an action based on the actionable segment identified by analytics module 704. In one example, action module 706 can generate a list of possible actions and communicate said list to a relevant realtor. In another example, action module can include an advertisement module 708. Advertisement module 708 can match specified client entities in the client list with a targeted advertisement based on the actionable segment assigned to the specified client entities. In one example, advertisement module 708 can implement steps 108 and 110 of process 100 supra. Advertisement module 708 can include various media templates for automatically generating advertisements that a realtor can provide to a client (e.g. via e-mail, text message, physical pamphlet, web page, etc.). In this way, advertisements can be automatically personalized to the specific situation of a realtor's client. Advertisements can also be event based (e.g. timely display of a realtor's just listed, sold, open houses, etc.). For example, the actionable segment indicates that the client has a higher than normal probability of putting her home up for sale and downsizing to a local condominium. The advertisement can be an email that reminds the client that the realtor is a specialist in selling homes in her neighborhood, as well as a specialist in local condominiums.

It is noted that advertisements can be automatically updated when it is detected that a client's situation has changed. For example, a recent move out of a client-home owner's child to attend university (e.g. the client is now an ‘empty nester’) can be utilized as a factor to determine that the client's actionable segment is ‘move down’ (e.g. sell current home and purchase a smaller home). An advertisement targeting the client can be generated and emailed to the client. The advertisement can list local ‘move down’ real estate options. However, it can be detected that the home owner's child recently returned to live at home. The client's actionable segment can be modified to ‘ignore’, as the probability of the client moving is once again determined to be low. The targeted advertisement can be automatically modified to a generic ‘reminder’ advertisement that no longer mentions possible ‘move down’ real estate options. It is noted that real-estate analysis server 700 can include other functionalities such as web servers, email servers, external short messaging entities and other text-messaging systems, media content editors, etc.

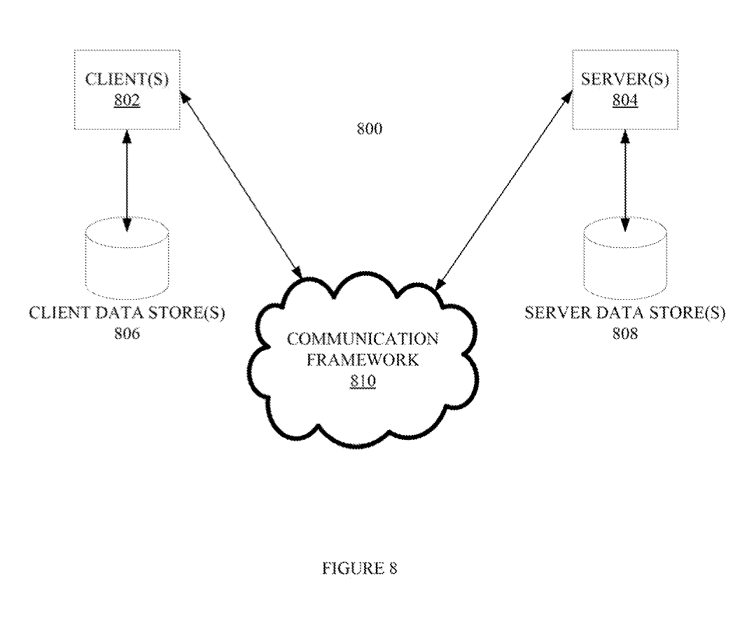

FIG. 8 is a block diagram of a sample computing environment 800 that can be utilized to implement some embodiments. The system 800 further illustrates a system that includes one or more client(s) 802. The client(s) 802 can be hardware and/or software (e.g., threads, processes, computing devices). The system 800 also includes one or more server(s) 804.

The server(s) 804 can also be hardware and/or software (e.g., threads, processes, computing devices). One possible communication between a client 802 and a server 804 may be in the form of a data packet adapted to be transmitted between two or more computer processes. The system 800 includes a communication framework 810 that can be employed to facilitate communications between the client(s) 802 and the server(s) 804. The client(s) 802 are connected to one or more client data store(s) 806 that can be employed to store information local to the client(s) 802. Similarly, the server(s) 804 are connected to one or more server data store(s) 808 that can be employed to store information local to the server(s) 804.

In some embodiments, system 800 can be include and/or be utilized by the various systems and/or methods described herein to implement processes 100, 200, 400 as well as other processes. Processes 100, 200, 400 and/or the data dictionary of FIG. 3 can be stored in 906 and/or 908. Client 902 can be in an application (e.g. a CRM application) operating on a realtor's computer such as a personal computer, laptop computer, mobile device (e.g. a smart phone) and/or a tablet computer. In some embodiments, server(s) 904 and/or data store(s) 908 implemented in a cloud computing environment.

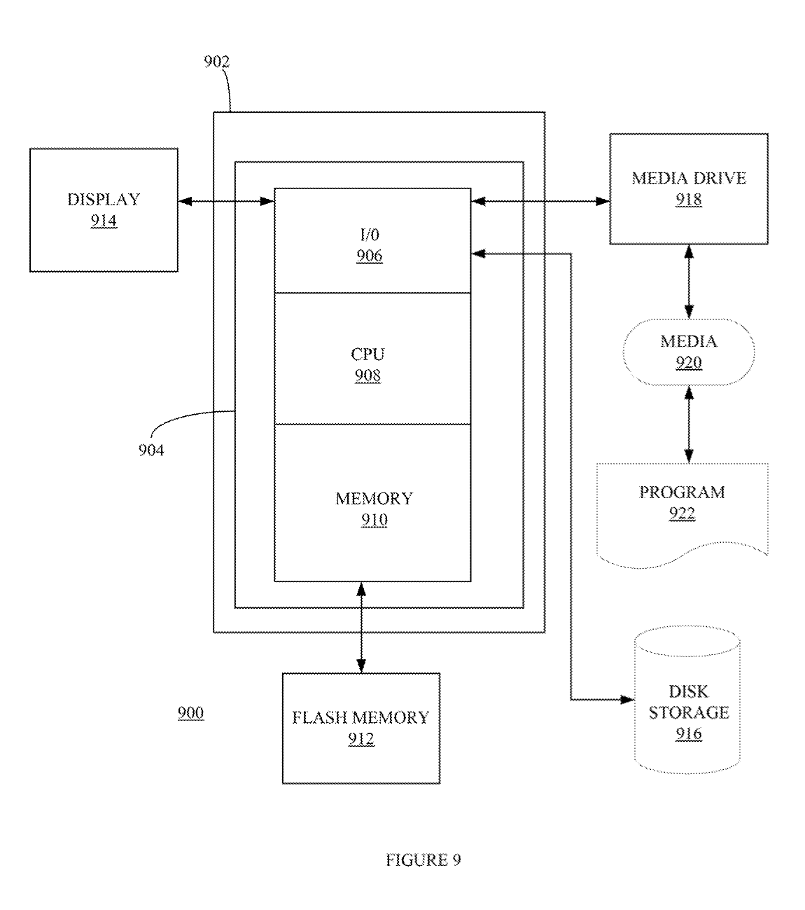

FIG. 9 depicts an exemplary computing system 900 that can be configured to perform any one of the processes provided herein. In this context, computing system 900 may include, for example, a processor, memory, storage, and I/O devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform any of the processes described herein. The main system 902 includes a motherboard 904 having an I/O section 906, one or more central processing units (CPU) 908, and a memory section 910, which may have a flash memory card 912 related to it. The 1/O section 906 can be connected to a display 914, a keyboard and/or other user input (not shown), a disk storage unit 916, and a media drive unit 918. The media drive unit 918 can read/write a computer-readable medium 920, which can contain programs 922 and/or data. Computing system 900 can include a web browser. Moreover, it is noted that computing system 900 can be configured to include additional systems in order to fulfill various functionalities. In another example, computing system 900 can be configured as a mobile device and include such systems as may be typically included in a mobile device such as GPS systems, gyroscope, accelerometers, cameras, augmented-reality systems, etc. In one example, the system of FIG. 9 can be utilized to implement processes 100, 200, 300 and the examples of FIGS. 1-7.

The following table can be utilized to define various variables utilized herein for classification operations provided supra.

| | |
|---|---|
| unitPrice = price/sqft | appr_hold = |
| | appr_since_last/current_hold_days |
| unitSqft = sqft/beds | apprPrice = appr_since_last * price |
| sqftPrice = price* sqft | yearPrice = year_built*price |
| yearSqft = year_built* sqft | ltvPrice = ltv_new * price |
| priceSquare = price * price | sqftHold = sqft* current_hold_days |

The following variables can be utilized in some clustering operations: ptype_price/sqft, ptype_sqft/beds, ptype_yearBuilt, ptype_lot_size/sqft, age, unitHHsize (beds/hh_size), bedBath (beds/baths), HH_Income_Percentile(HH_Income/median(HH_Income)), priceIncome (price/HH_Income), working_woman, sr_adults, kids_{—}16_{—}17.

The following data dictionary can be utilized to implement various variables of example processes and system provided supra. ‘beds’ can mean bedrooms. ‘ptype’ can mean a binary flag indicating whether the property is a Single Family Household (SFH) or an Apartment/Condo (AC). ‘price’ can mean the estimated price of the property. ‘sqft’ can mean estimated, livable size of the property measured in square feet. ‘year_built’ can mean estimated year in which the property was built. ‘current_hold_days’ can mean total days property has been owned by the current owner. ‘NOD’ can mean a binary flag indicating whether the property has defaulted on their home loan between the observation period and current month. ‘ltv_new’ can mean the total balance of the loan for the property at the time of observation divided by the estimated price (AVM) of the property at the same time. ‘appr_since_last’ can mean the net change between the estimated sale price from the property's previous sales event and the property's estimated price (AVM) at the time of observation. ‘sales_hy10’ can mean the total known times a property has been sold previous to the observation period. ‘age_cat can mean an Age Group of individual based on either date of birth or other statistical data. ‘HH_Income’ can mean an estimated household income group. ‘Hh_size’ can mean a total number of occupants in the household. ‘working_woman’ can mean a working woman is present in the household. ‘sr_adults’ can indicates that there is a senior adult (e.g. an adult of greater than fifty-five (55) years in age) in the household where another adult is identified as the 1 st individual. ‘kids_{—}16_{—}17’ can mean a total sixteen to seventeen (16-17) year olds possibly in the household. ‘ptype_price’ can mean a median estimated price per property type. ‘p_type_sqft’ can mean a median building area per property type. ‘ptype_yearBuilt’ can mean a median year built per property type.

In one prediction method, ensemble methods can be used in a training data phase. Ensemble method can use multiple learning algorithms to obtain better predictive performance than could be obtained from any of the constituent learning algorithms. Example machine learning algorithms can include, inter alia: logistic regression algorithms, balanced random forest algorithms, regular random forest algorithms, etc. Training data phase can generate models, and a test data phase can be used to choose a set of champion models and the corresponding weights to combine the champion models. The test data phase can generate model as well. The test data phase can use the champion models and weights picked from the training data phase. An average can be taken from the two or more probability results. Ensemble learning can also use a set of weak learnings and ensemble them together to deliver unexpected good result. A weight loop can be provided and pre-tested weight ranges can be used to ensure to deliver the best choices.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A method of real-estate client management comprising:
receiving a realtor's client contact list;
matching an client entity of the client contact list with a real-estate entity, wherein the real-estate entity comprises a real-estate property owned or leased by the client entity;
obtaining a real-estate entity attribute database from a real-estate entity attribute aggregator;
determining a real-estate entity attribute from the real-estate entity attribute database;
assigning the real-estate entity attribute to the client entity; and
based on the real-estate entity attribute, assigning a predicted future action to the client entity with respect to the real-estate entity.

2. The method of claim 1 further comprising:
obtaining a client-entity attribute database from a client-entity attribute aggregator;
determining a client-entity attribute from the client-entity attribute database; and
based on the client-entity attribute or the real-estate entity attribute, assigning the predicted future action to the client entity with respect to the real-estate entity.

3. The method of claim 2, wherein the future action comprises a prediction that the client entity will sell the real-estate entity.

4. The method of claim 3, wherein the future action comprises a prediction that the client entity will sell the real-estate entity and purchase a smaller-sized real-estate entity.

5. The method of claim 3, wherein the future action comprises a prediction that the client entity will sell the real-estate entity and purchase a larger-sized real-estate entity.

6. The method of claim 2, wherein the client-entity attribute comprises a demographic attribute of the owner of the real-estate entity.

7. The method of claim 2, wherein the real-estate entity attribute comprises a size of a home.

8. The method of claim 2 further comprising:
automatically generating a digital advertisement targeted to the future action of the client entity.

9. The method of claim 8 further comprising:
detecting a change in the real-estate entity attribute or the client-entity attribute;
automatically modifying the future action of the client entity; and
automatically modifying the digital advertisement targeted to the modified future action of the entity.

10. A computerized system comprising:
a processor configured to execute instructions;
a memory containing instructions when executed on the processor, causes the processor to perform operations that:
receive a realtor's client contact list;
match an client entity of the client contact list with a real-estate entity, wherein the real-estate entity comprises a real-estate property owned or leased by the client entity;
obtain a real-estate entity attribute database from a real-estate entity attribute aggregator,
determine a real-estate entity attribute from the real-estate entity attribute database;
assign the real-estate entity attribute to the client entity;
obtain a client-entity attribute database from a client-entity attribute aggregator;
determine a client-entity attribute from the client-entity attribute database; and
based on the client-entity attribute or the real-estate entity attribute, assign the predicted future action to the client entity with respect to the real-estate entity.

11. A computer-implemented method of real-estate entity segmentation comprising:
classifying a set of property attributes of one or more real-estate entities using a logistic regression method, wherein the real-estate entities are taken from a realtor's client contact list;
determining a probability of a real-estate transaction occurring for each of the one or more real-estate entities based on the set of property attributes of the one or more real-estate entities;
identifying that a real-estate entity is more likely being sold or listed when the probability of a real-estate transaction occurring is above a specified threshold; including the real-estate entity that is more likely being sold or listed in a clustering data set;
implementing a fuzzy-C means clustering algorithm on all or a portion of the clustering data set to obtain a cluster center for a specified set of the property attributes;
classifying the real-estate entity to a real-estate segment based on a location of the real entity in the cluster;
adding the real-estate entity to the real-estate segmentation.

12. The computer-implemented method of claim 11 further comprising:
scaling the one or more real-estate entities within a tract.

13. The computer-implemented method of claim 12 further comprising:
calculating a kurtosis value, a skewness value, a variance value, a median value, a tract size value and an event-rate value for the tract.

14. The computer-implemented method of claim 13, wherein a scaling-operation comprises a scaling equation, wherein the scaling equation comprises: (prob−min(prob))/(max(prob)−min(prob)), and wherein the scaling equation scales a set of real-estate entities within the same tract.

15. The computer-implemented method of claim 14, wherein the specified threshold comprises between a twenty (20) percentile to eighty (80) percentile of probability of being sold or listed.

16. The computer-implemented method of claim 15, wherein probability threshold is determined based on an F-score.

17. The computer-implemented method of claim 16, wherein further comprises: building a fuzzy-c means;
setting a cluster number to three (3);
obtaining a cluster center; and
segmenting a set of properties by a majority vote.

18. The computer-implemented method of claim 11, wherein the real-estate segment comprises a move-up segment, a move-down segment or a not moving segment.
